(19) United States
(12) Patent Application Publication
(10) Pub. No.: US 2008/0208695 A1
(43) Pub. Date: Aug. 28, 2008

(54) System and method for improved retail sales

(76) Inventor: James Condron, Wilton, CT (US)

Correspondence Address: SOFER & HAROUN LLP., 317 MADISON AVENUE, SUITE 910, NEW YORK, NY, 10017, US

(21) Appl. No.: 12/069,558

(22) Filed: Feb. 11, 2008

Related U.S. Application Data
(60) Provisional application No. 60/901,011, filed on Feb. 12, 2007.

(51) Int. Cl. G06Q 30/00

(52) U.S. Cl. 705/14; 705/27

(57) ABSTRACT

A system for facilitating retail sales includes a kiosk located in a retail establishment, and maintained and operated by a third party, apart from the retail establishment. The kiosk couples with at least one vendor having one or more items for sale and displays the one or more items for sale on a interactive screen. The kiosk receives input from the third party and the retail establishment regarding the price one or more items for sale. The kiosk receives input, through the interactive screen, from a user desiring to purchase at least one item for sale from the vendor, where the transaction is handled by the third party operating the kiosk with delivery of a portion of the profits from the sale are delivered to the retail establishment by the third party.

### RELATED APPLICATION

This application claims the benefit of priority from U.S. Provisional Patent Application No. 60/901,011, filed on Feb. 12, 2007, the entirety of which is incorporated by reference.

### FIELD OF THE INVENTION

This invention relates to the field of retail sales. More particularly, the present invention relates to a system and method for improving retail sales using the internet.

### BACKGROUND

In the area of retail sales, typically brick-and-mortar stores are required to carry a large stock inventory to cover the widely ranging demands of their consumers. For example, in the area of sports retail establishments, where numerous variations of products are available, each for the many different teams within a sport, it is difficult for a brick-and-mortar store to maintain a sufficient supply of stock items to satisfy all customers.

In the prior art, the burden for stocking such items falls squarely on the retailer. This often results in failure to meet the consumer needs, or, the opposite problem of overstocking, each of which has their associated costs.

Additionally, with the rise of on-line shopping, consumers are shifting away from brick-and-mortar shops and perform more of their shopping from home. These on-line stores do not have the same problems with stocking the various retail items because they do not have to maintain expensive on-retail-location stock rooms and supplies.

### OBJECT AND SUMMARY

The present invention looks to overcome the drawbacks associated with the prior art by providing a kiosk that allows consumers, within a brick-and-mortar store to place an order for a product on-line. In the arrangement of the present invention, a 3^{rd} party supplier may introduce a kiosk or other internet facilitated retail sales into a brick-and-mortar retail establishment, that allows the retail store, for certain product lines, to reduce the amount of stock on hand needed to meet customer demands.

It is thus an object of the invention to provide an electronic kiosk that narrowcasts product-programming and services in selected in-house retail settings, such as sports departments and merchandising arrangements. In this arrangement, a variety of vendors, who have previously provided only physical products directly to these retailers, may, using the present invention, present licensed products, using the kiosk, within the store without the need for the store itself to stock the physical items for sale. The kiosk may be managed directly by the retail establishment, or advantageously by a third party so that there is no need to provide additional kiosk managing staff.

Product offerings on such kiosks may include but are not limited to sports results, sports apparel, stock prices, news, merchandising items etc. . . . Additionally, such product offerings may be electronically updated in real time via an integrated information management system that is included within the kiosk. As such, new product offerings and discontinued items are immediately updated so that new items are always available and so that improper orders on older items are not taken.

Such kiosks satisfy retailers' need for improving profitability by reducing the need to carrier large quantities of stock to meet customer demands. Thus, the system has the capability of allowing retailers to expand selling floor space for other items, while eliminating the need for additional inventory expense on the items intended to be sold through the kiosks. Such a system allows retailers to sell items that have not been traditionally carried in their stores due to cost or size.

It is another object of the invention for the retailer to reduce other components of working capital, as receivables and payables for the sold retail items may be eliminated through short term fee-based electronic reimbursements from the third party manager of the kiosks. In this manner, the kiosk program allows retailers to make product e-sales in highly promoted in-store settings without the in-store inventory, as products are shipped directly by the vendors/producers participating in the system or by the manufacturer of the electronic kiosk.

Vendors of the goods sold through such kiosks are provided the advantage of having their goods promoted within the store in a high visibility manner.

To this end, the present invention provides for a system for facilitating retail sales includes a kiosk located in a retail establishment, and maintained and operated by a third party, apart from the retail establishment. The kiosk couples with at least one vendor having one or more items for sale and displays the one or more items for sale on a interactive screen. The kiosk receives input from the third party and the retail establishment regarding the price one or more items for sale. The kiosk receives input, through the interactive screen, from a user desiring to purchase at least one item for sale from the vendor, where the transaction is handled by the third party operating the kiosk with delivery of a portion of the profits from the sale are delivered to the retail establishment by the third party.

### BRIEF DESCRIPTION OF THE DRAWINGS

The present invention can be best understood through the following description and accompanying drawings, wherein:

FIG. 1 illustrates an exemplary kiosk for a retail sale system, in accordance with one embodiment of the present invention;

FIG. 2 illustrates an exemplary kiosk for a retail sale system, in accordance with another embodiment of the present invention;

FIG. 3 illustrates an exemplary kiosk for a retail sale system, in accordance with another embodiment of the present invention;

FIG. 4 is a flow chart for a set-up operation for a kiosk from any one of FIGS. 1-3, in accordance with one embodiment of the present invention;

FIG. 5 is a flow chart for a set-up operation for a kiosk from any one of FIGS. 1-3, in accordance with another embodiment of the present invention;

FIG. 6 illustrates a flow chart for operation of the kiosks from any one of FIGS. 1-3, in accordance with one embodiment of the present invention;

FIG. 7 illustrates a flow chart for operation of the kiosks from any one of FIGS. 1-3, in accordance with another embodiment of the present invention; and

FIG. 8 is a report chart showing the activity on any one of the kiosks of FIGS. 1-3, in accordance with one embodiment of the present invention.

### DETAILED DESCRIPTION

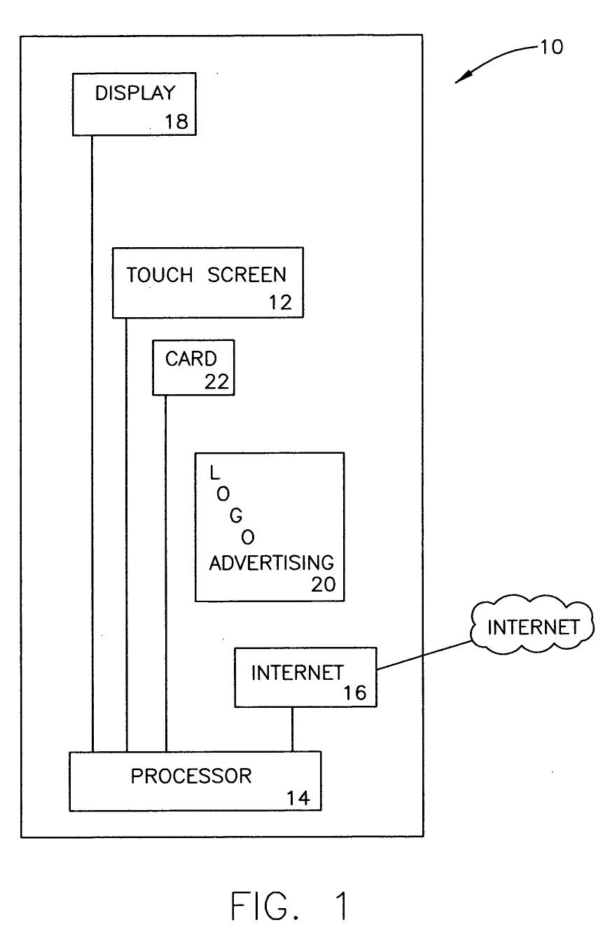

In one embodiment of the present invention, as illustrated in FIG. 1, a retail sales system employs a kiosk 10, to be placed within a retail establishment to assist customers in reviewing and purchasing products or information. Kiosk 10 employs a typical touch screen 12, such as an LCD (Liquid Crystal Display) screen, that allows A user to browse and purchase products. Touch screen 12 is connected to a processor module 14 that employs the necessary software and hardware for supporting touch screen 12.

Processor 14 module is ideally coupled to the internet via a high speed wireless/wireline internet connection 16. Internet connection 16 allows processor 14 to couple with one or more desired product vendors to receive the necessary product information for supporting display and sale of the intended products. In one arrangement, processor 14 is supported and managed directly by the retail establishment in which kiosk 10 is located. In second arrangement, processor 14 is supported and managed by a third party operator, working with both the retail establishment and the product vendors so that the retail establishment does not need to perform any support functions on their own. A detailed discussion of the operation of kiosk 10 is outline below.

It is understood that processor 14 may execute independent programming on touch screen 12, with data and other supporting information being supplied directly by third party operators or vendors via internet connection 16. Alternatively, processor 14 may simply act as a local supporting processor with the vendors supplying all interactive processing (graphics, data collection etc. . . . ) directly through internet connection 16. The present invention may be implanted in either manner or in any combination thereof.

Optionally, kiosk 10 may further employ a secondary display screen 18 that is primarily for displaying advertising graphics to attract potential users to kiosk 10. Similar to touch screen 12, display screen 18 may employ LCD technology or other such electronic formats (plasma etc. . . . ). Advertising displayed on display screen 18 may be basic static advertising, video advertising or even promotional advertising such as the display of coupons or discounts that may be obtained by using kiosk 10 at a certain time or for certain product lines.

In another embodiment of the present invention, kiosk 10 may have static advertising area 20 that may be pre-fabricated with logos or other such advertising/trademark material that may relate to either the retail location, vendors selling the items within kiosk 10 or to the third party operators. Alternatively, advertising area may simply be a designated area for receiving vinyl or plastic advertisement/posters that may be periodically changed, based on the items being sold through kiosk 10.

It is contemplated that the retail establishment may derive revenue by leasing out display screen 18 and advertising area 20 to interested advertisers. Such advertising may be directed to highlighting products that can be purchased through kiosk 10, and displaying demographic specific video content which draws the best customers to kiosk 10 to make purchases. Advertising income coming from display screen 18 may supplement direct-sale income derived from product purchased through kiosk 10. Additional descriptions of advertising management are detailed below.

In one embodiment of the present invention, kiosk 10 may employ a card reader 22 that is used to receiving payment for purchased items. Optionally, card reader 22 may be capable of additionally accepting bills for cash payment and also for distributing receipts or order confirmations. The complete payment process for items purchased through kiosk 10 is explained in more detail below.

It is contemplated that the physical dimensions of kiosk 10 cover approximately 4 square feet, however the invention is not limited in that respect.

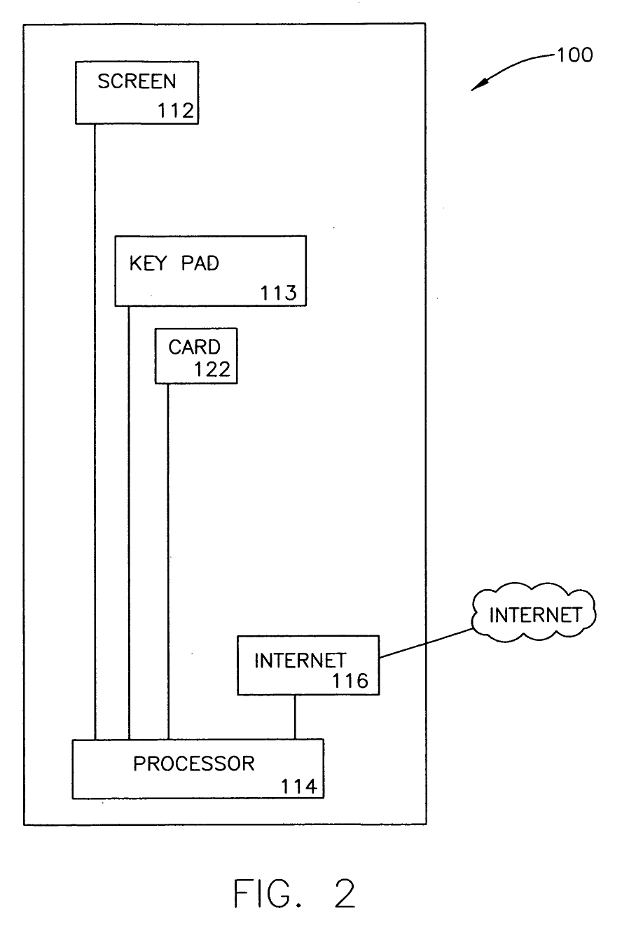

In another embodiment of the present invention, as illustrated in FIG. 2, and alternative form of kiosk 100 employs a more traditional screen 112 and keypad 113. Otherwise, kiosk 100 employs the other components of kiosk 10 as described in detail above.

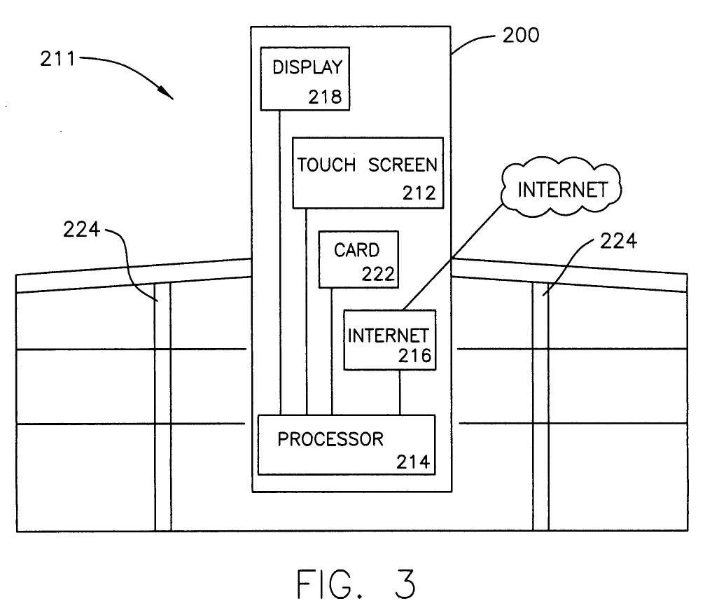

In yet another embodiment of the present invention, as illustrated in FIG. 3, a kiosk 200, similar to kiosk 10 as described above if incorporated into a full display arrangement 211 including a touch screen 212, processor 214, internet connection 216, display screen 218, and advertising screen 220. However, arrangement 211, further includes display cases 224 that may be used for various purposes such as displaying sample merchandise items, providing a surface for customer services, and possibly a storage area for sizing samples for apparel sold through kiosk 200.

It is understood that the above described kiosks 10, 100 and 200 and their components are merely exemplary and are no way intended to limit the scope of the present invention. Any similar kiosks that employ components to affect in-store on-line shopping are also within the contemplation of the present invention.

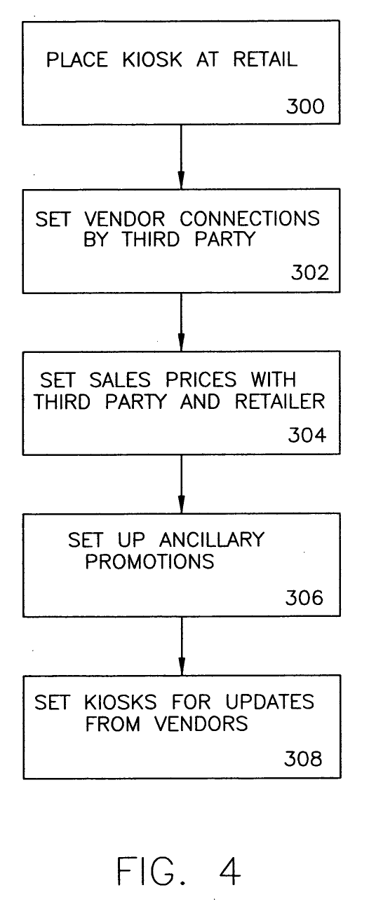

Tuning now to the operation of kiosks 10, flow chart FIG. 4 illustrates the set up process for kiosk 10. It is understood that kiosk 10 is being used to illustrate the salient features of the function of the kiosks, however, the following steps are equally applicable to any of the above described kiosks 10, 100 and 200.

FIG. 4 illustrates a first embodiment of the present invention, whereby kiosk 10 is managed and maintained by a third party operator between the retail establishment and the vendor(s).

In a first step 300, third party operator places a kiosk 10 into the retail establishment in the desired location. Thereafter, at step 302, the third party operator establishes the connection or connections with the desired vendor(s) of the products intended to be sold through the retail establishment. For example, assuming the retail establishment desires to sell sporting apparel hats for various professional sports leagues, the thirds party operator of kiosk 10 may establish connections with each of the sporting leagues (eg. NBA, NFL, MLB, NHL etc. . . . ) for the hats to be sold. Such connection is established via processor 14 and internet connection module 16.

After the third party establishes the desired connection to the product vendors, at step 304, the third party operator then sets up the sales options with the retail establishment. For example, the vendors of the products have a wholesale price for each of their various goods. The retail establishment, working with the third party operator may set the various retail sales prices of such items according to the various income desires as well as any preexisting agreements.

Once retail sales prices are set, at step 306, any ancillary programming may be set up by the third party operator. For example, advertisements, promotions and other visual and promotional arrangements may be made for display screen 18 and advertising space 20 so that the retail establishment may set any additional revenue streams regarding advertising space. It is understood that although such advertising may be set by the retail establishment, it is also within the contemplation of the invention, that such advertising and promotions may be sent directly from the third party operator or vendor(s), depending on contractual arrangements.

At step 308, once all set up arrangements are complete, kiosk 10 is set for accepting incoming orders from users. During such phase, the third party operator configures processor 14 to accept periodic updates from the vendor(s) so to keep updated pricing and product line information in either a real time or frequent periodic basis.

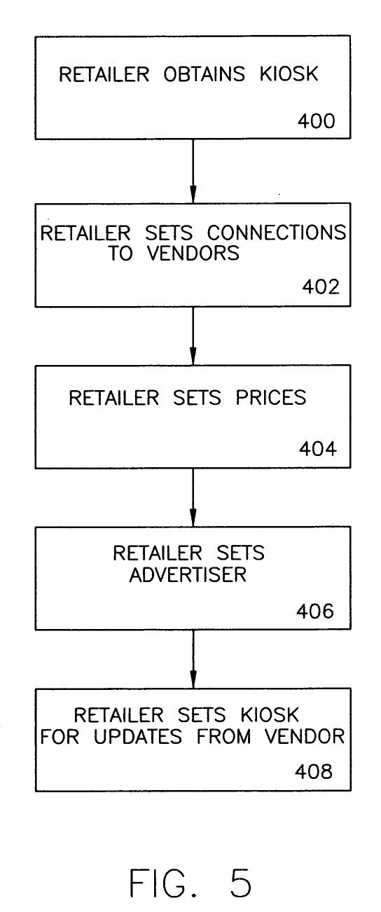

In an alternative arrangement, FIG. 5 shows a flowchart whereby kiosk 10 is managed directly by the retail establishment rather than a third party operator. In such an arrangement, Step 400 the retail establishment purchases or leases a kiosk 10 and at step 402, establishes the connection or connections with the desired vendor(s) of the products intended to be sold.

After the retail establishment establishes the desired connection to the product vendors and programs them into processor 14, at step 404, the sales price options are set based on the various income desires as well as any preexisting agreements. Once retail sales prices are set, at step 406, the ancillary advertising programming is set, including advertisements, promotions and other visual and promotional arrangements for display screen 18 and advertising space 20.

At step 408, once all set up arrangements are complete, kiosk 10 is set for accepting incoming orders from users. During such phase, the retail establishment configures processor 14 to accept periodic updates from the vendor(s) so to keep updated pricing and product line information in either a real time or frequent periodic basis.

In either of the above arrangements, it is contemplated that processor 14 may employ internal programming for displaying products and taking orders for products, whereby vendor(s) simply supply the data necessary for such transactions. Alternatively, processor 14 may be configured as a conduit, whereby the third party operator or retail establishment configures kiosk 10 as simply a portal device to operate programming supported directly by the vendor(s) on their own servers.

Such an arrangement, as described above allows the retail establishment to provide a wide range of product lines to their customer without the need to dedicate floor and storage space to stocking products. Such an arrangement is particularly advantageous for use in the sales of items where wide varieties of styles and sizes make maintaining a complete stock impractical. For example, kiosks 10 may be used for sporting goods, non-primary items (like car accessories at car dealer/car maintenance establishment), large items, items with great number of variables (sporting apparel), information to supplement other products like stock quotes or sports scores at airports or sporting good stores, and even update services or products such as cell phone accessories or services.

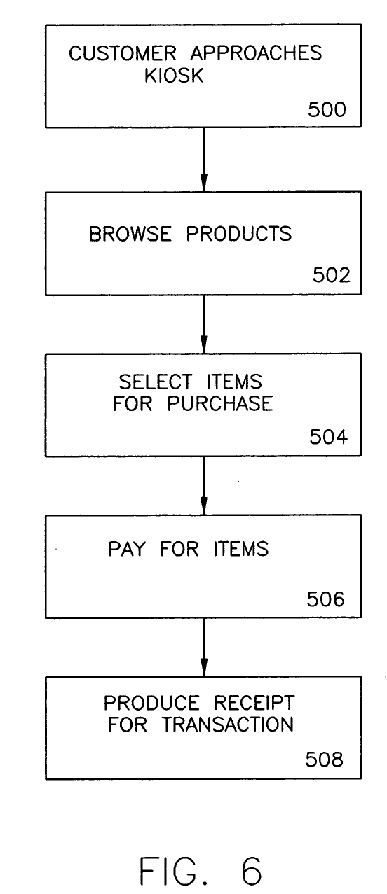

In one embodiment of the present as show in Flow chart FIG. 6, a user is able to purchase and item for sale from kiosk 10. In this example, the entire transaction is performed through the kiosk, including payment and shipment (information).

At a first step 500, a customer approaches touch screen 12 and navigates one or more browsing screens to select an item for purchase. Such browsing process may include, but is not limited to, product selection, product information, style selection, color selection, and any other variable selection that may be related to the final product.

At step 502, the customer, after navigating the various product screens makes one or more selections for purchase. After selection of the purchase item(s), at step 504, the customer is brought to a checkout screen whereby they are prompted to make payment and item delivery options.

In one arrangement of the present invention, at step 506, card reader 22 reads the user's card with both magnetic stripes and/or 2D bar codes, allowing for debit or credit transactions. In one option, a driver's license card may be used to make the purchase process more efficient by allowing for automatic entry of the customer's card's billing address, saving valuable time.

At step 508, once the items are ordered by the customer, the order is sent via processor 14 to the vendor for completion of the order. At this stage, the order is automatically sent to the relevant licensee/vendor via the internet for it to be fulfilled. Any confirmation data or receipt may be printed by card reader printer 22 so that the customer may have any necessary delivery estimates and order confirmation information.

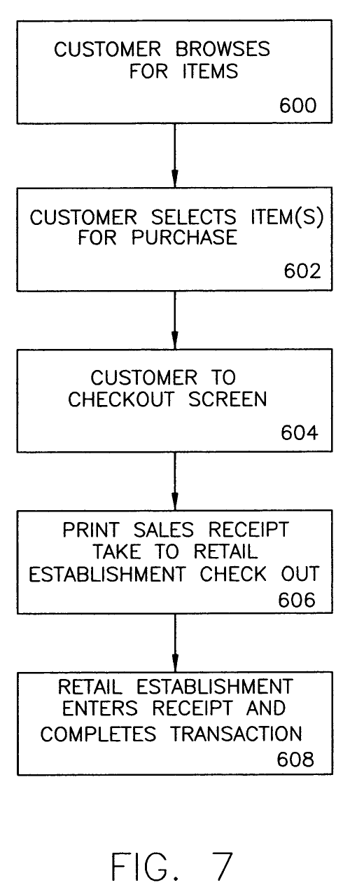

In one embodiment of the present invention, as illustrated in flow chart FIG. 7 a second process for purchasing an item from kiosk 10is shown whereby the order is only partially completed at kiosk 10 and payment and/or shipment is handled by the retail establishment.

For example, in step 600, a customer navigates one or more browsing screens on touch screen 12 to select an item for purchase. At step 602, the customer makes one or more selections for purchase and at step 604, the customer is brought to a checkout screen whereby they are prompted to make payment and item delivery options.

At step 606, rather than completing the transaction at kiosk 10, the user prints a receipt for the order item(s) from card reader/printer 22 and takes the receipt to the cashier of the retail store along with other items for purchase if desired. Such a receipt may include a bar code or other alphanumeric code that includes all of the relevant information needed to complete the purchase. At step 608, the retail establishment enters the receipt of kiosk 10 into their normal checkout process so as to complete the order and obtain payment from the customer.

This allows the user to pay at the register rather than the kiosk, which may allow for more payment options, and may provide an additional sense of security to certain customers who are uncomfortable with completing on line transactions. Furthermore, such a process ay be used where home delivery of the product from kiosk 10 is not intended, but rather shipment to the retail establishment is intended for some other reason. For example, the customer may simply wish to pick the product up at the store (eg. for surprise gifts) or they may desire some in-store customization (eg. engraving) before taking the product home. It is within the contemplation of the present invention that the same kiosk 10 may be capable of both handling both complete transactions as outlined in FIG. 6 or for completing in-store assisted transactions as outlined in FIG. 7.

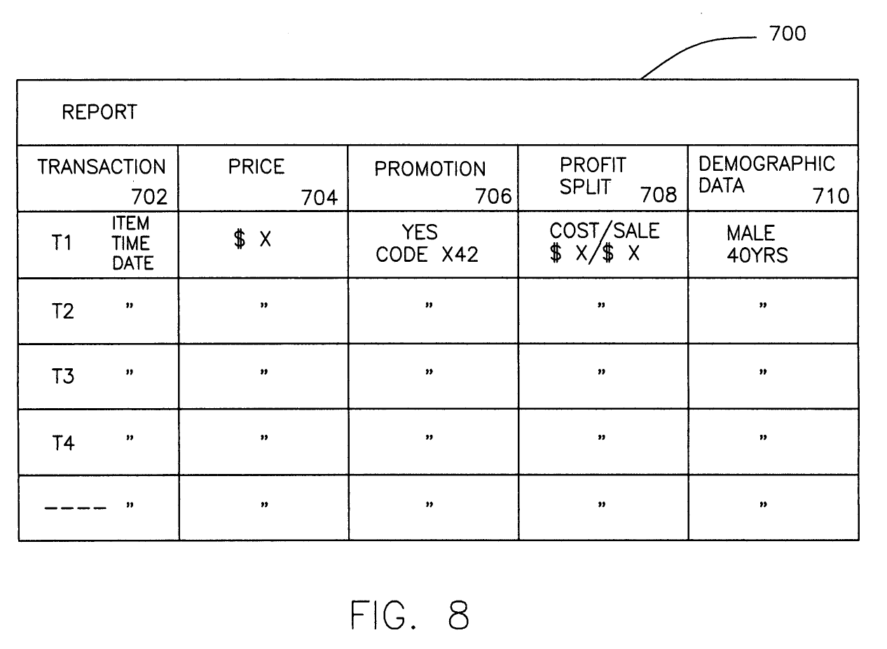

In another embodiment of the present invention, as illustrated in FIG. 8, kiosk 10 and/or the third party operator, a report 700 may be issued on a periodic basis (ie. Daily, weekly, monthly, transaction-by-transaction, etc. . . . ). Report 700 may include a listing (time and date of a transaction) 702, as well as sale amounts 704, promotions used 706, profits estimates 708 as well as other demographic data 710 which may be useful in targeting future products and advertising.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for facilitating retail sales, said system comprising:
a kiosk, said kiosk being located in a retail establishment, and being maintained and operated by a third party, apart from said retail establishment, said kiosk configured to,
couple with at least one vendor having one or more items for sale;
display said one or more items for sale on a interactive screen;
receive input from said third party and said retail establishment regarding the price one or more items for sale;
receive input, through said interactive screen, from a user desiring to purchase at least one item for sale from said vendor, wherein said transaction is handled by said third party operating said kiosk with delivery of a portion of said profits from said sale are delivered to said retail establishment by said third party.

2. The system as claimed in claim 1, wherein said kiosk is coupled to said vendors via the internet.

3. The system as claimed in claim 1, wherein said kiosk is coupled to two or more vendors.

4. The system as claimed in claim 1, wherein said kiosk has a processor for managing programming to support the sale of said items.

5. The system as claimed in claim 1, wherein a wholesale price associated with said items is set by said vendor, and wherein a retail price is set by said third party and said retail establishment, with an associated agreement regarding profits.

6. The system as claimed in claim 1, wherein said kiosk further comprises a display screen for displaying any one of advertisement and promotions.

7. The system as claimed in claim 1, wherein said kiosk further comprises a coupled display case for containing sample items for sale through said kiosk.

8. The system as claimed in claim 1, wherein a transaction conducted on said kiosk is completed entirely at said kiosk.

9. The system as claimed in claim 1, wherein a transaction conducted at said kiosk is partially performed at said kiosk, such that a selection of an item is performed at said kiosk, resulting in a printed receipt for said item.

10. The system as claimed in claim 9, wherein said printed receipt is taken to a check-out counter at said retail establishment to complete payment and delivery options for said transaction.

11. The system as claimed in claim 1, wherein said kiosk generates periodic reports for said retail establishment regarding purchases coducted on said kiosk.
